(19) United States
(12) Patent Application Publication
(10) Pub. No.: US 2023/0069276 A1
(43) Pub. Date: Mar. 2, 2023

(54) DEVICE FOR ANALYSING SOLID BIOLOGICAL ELEMENTS AND DEVICE FOR IMPLEMENTING SAME

(71) Applicant: L'ETAT FRANÇAIS REPRÉSENTÉ PAR LE MINISTÈRE DE L'INTÉRIEUR, Issy-Les-Moulineaux (FR)

(72) Inventors: Amaury PUSSIAU, Miami Beach (US); Sylvain HUBAC, Miami Beach (US)

(21) Appl. No.: 17/759,790

(22) PCT Filed: Jan. 29, 2021
(86) PCT No.: PCT/EP2021/052117

§ 371 Date: Jul. 29, 2022

(30) Foreign Application Priority Data
Jan. 31, 2020 (FR) FR2000959

(51) Int. Cl. B01L 3/00

(52) U.S. Cl. CPC B01L 3/50255; B01L 3/50853; B01L 3/5023; B01L 3/502753; B01L 2300/021; B01L 2300/042; B01L 2200/0684

(57) ABSTRACT

The invention relates to a device for analyzing solid biological elements and to a device for implementing same. The device comprises a plate (1) of tubes, the lower ends (2) of which are perforated and the upper ends (4) of which are open on the tube plate (1) to allow the introduction of an element to be analyzed (5), a deep-well plate (6) into which the tube plate (1) is inserted and a lifter (7) for raising the tube plate (1) from the deep-well plate (6). Each tube (3) in the tube plate (1) comprises at least one opening (9) toward its upper end (4) to allow air to pass through and each tube (3) can be closed at its upper end (4) with a stopper (8). The invention is applicable particularly in the medical, agri-food and forensic science fields.

The present invention relates to a device for analyzing solid biological elements and to a device for implementing same.

Historically, sampling and cell lysis devices were designed to process only one sample at a time. For example, the “Forensic Spin Filter basket” device marketed by the company MidSci is composed of a filtration unit with a perforated bottom making it possible to collect a biological sample and of a 2 mL collection tube with an attached cap. In alternative versions of this type of device, the cap can be secured to the filtration unit instead of being attached to the collection tube, or else the filtration unit and the collection tube can both have an attached cap.

The first step in the analysis process consists in inserting the solid biological element, also called specimen or sample (e.g.: piece of fabric, cigarette filter paper, hair, etc.), into the filtration unit, which is then inserted into the collection tube. A buffer or solvent suitable for cell lysis is added to cover the sample. The sample is thus immersed in the buffer at the filtration unit. The device is closed using the cap secured to the collection tube or the filtration unit and then incubated for a given time. The assembly is then centrifuged in a micro-centrifuge in order to separate the buffer from the biological sample, the buffer passing through the micro-pores located at the bottom of the filtration unit to end up in the collection tube. Depending on the devices, the filtration unit can be directly removed from the collection tube, or may require a prior step of opening the cap. The collection tube containing the lysate is then used to perform DNA purification.

The device described above is not suitable for processing more than one sample at a time. It is necessary to multiply the number of devices as many times as necessary according to the number of samples to be processed, which increases the number of manual steps to be carried out accordingly.

In document US-5888831-A, a collection and extraction container is described for recovering the lysis buffer using a syringe without the need to remove the filter basket containing the sample, and without the need to reopen the collection tube cap. However, this device also does not make it possible to process several samples at the same time and requires a pipetting step using a syringe to recover the lysis buffer.

The device described in document US-2010248213-A is based on the same principle as the previous device with the advantage of being able to process several samples simultaneously. Nevertheless, the method used presents risks of cross-contamination during the sampling process because the containers containing the biological material are only sealed after the insertion of all the samples and the addition of the lysis buffer.

Document WO-2009074177-A relates to a sampling device for collecting solid forensic samples in order to extract biological material therefrom. The device comprises a compartment in which the sample is inserted, then the lysis buffer. After incubation, the buffer is transferred into a well of a microplate located below via a vertical pouring channel, the transfer being carried out by a siphon. However, this device can only process up to 24 samples simultaneously.

Currently, the device generally used to carry out the sampling and the lysis of several samples simultaneously consists of a plate of 96 “spin baskets,” subsequently called tube plate, of a plate of 96 deep wells and of a means for separating the two, this means hereinafter being called “lifter.” To carry out the sampling, it suffices to insert the elements to be analyzed, for example cigarette filter paper, gauze, a piece of cloth, etc., one by one into each of the tubes of the tube plate. The traceability of the samples, that is to say, the identification of the position of each of the elements to be analyzed, is ensured by software internal to each laboratory.

With such a device, the different steps are:

an element to be analyzed is deposited in each tube of the tube plate, which is inserted in the deep-well plate;

the lysis solution is added to each tube in order to immerse the element to be analyzed;

the tube plate is covered with an adhesive film in order to close the free end of the tubes and thus to avoid any subsequent contamination during the analysis process;

this assembly is deposited in a heating system to carry out cell lysis with stirring;

at the end of this lysis, the tube plate is raised while keeping it inserted in the deep-well plate with the lifter and the samples are spun by centrifugation so that the lysis solution is entirely in the deep wells;

the tube plate and the lifter of the deep-well plate are removed. The deep-well plate, which therefore contains the lysate, is ready for the next step of nucleic acid purification.

It is noted that there is no safety guaranteeing an absence of contamination between the tubes of the same plate during and after the deposit of a sample. This safety is therefore not ensured as long as all the tubes of the plate are not covered by an adhesive film, which corresponds to waiting for the end of sampling of all the elements.

Furthermore, the length of the tubes of the tube plates currently used is not adapted to the depth of the deep wells of the deep-well plate: in fact, the sample is not completely immersed in the determined volume of lysis solution.

Thus, one of the aims of the present invention is to provide a device for analyzing solid biological elements making it possible to ensure non-contamination of the elements to be analyzed as well as traceability thereof.

Another object is to provide such a device that allows the element to be analyzed to be immersed as much as possible in the lysis solution.

An additional object of the present invention is to provide a method preventing the drawbacks set out above.

These objects, as well as others that will appear subsequently, are achieved by a device for analyzing solid biological elements comprising, on the one hand, a plate of tubes, the lower ends of which are perforated and the upper ends of which are open to allow the introduction of an element to be analyzed, which may contain biological material, and, on the other hand, a deep-well plate into which the tube plate is inserted, the deep-well plate comprising several deep wells, the device further comprising a lifter for raising the tube plate from the deep-well plate, each tube of the tube plate comprising, toward its upper end, at least one opening passing all the way through the wall of the tube to allow air to pass through, the device further comprising, for each tube of the tube plate, a stopper closing the upper end of the tube. The opening is a groove made in the wall of the tube, and opening up to the upper end of the tube.

Such a groove makes it possible to balance the air pressure between the inside and the outside of the tube. Indeed, the groove has a slot shape, such a slot shape being particularly suitable for optimizing the balancing of air pressure between the inside and the outside of the tube. Moreover, such a groove also makes it possible, by its shape, to make the opening visible from above the plate when no stopper is inserted in the tube. Thus, the operator can easily see that the sample does not come into direct contact with the groove, or failing that, that no element that may separate from the sample comes to obstruct this groove during the insertion of the sample into the tube. Conversely, the presence of a circular hole in the wall of the tube does not allow an operator to visualize from above that no sample is obstructing the hole. Finally, the slot of the groove defines a kind of linear guide that makes it easier to unblock the groove in the event that an element obstructs the latter. Such unblocking is for example very easily carried out via the insertion by the operator of a needle through the groove.

Preferably, the groove has a width in the range of 0.1 mm to 5 mm.

Preferably, each tube comprises a membrane positioned on or within the groove, preferably over the entire length of the groove, such a membrane being configured to allow only air to pass. Such a membrane, thus configured, thus prevents volatile compounds (and/or liquid) from escaping from the tube or from passing into the tube from the outside, in order to avoid any inter-sample contamination within the tube plate.

Preferably, the stopper obstructs the upper part of the groove at the upper end of the tube.

According to one embodiment of the invention, the deep wells have square sections and the opening(s) are arranged along the diagonals of this square section.

Advantageously, each tube comprises, on its outer wall, a non-return membrane cooperating with the inner wall of the corresponding deep well.

Preferably, this membrane is embedded in a reinforcement of the tube.

Advantageously, at one of its corners the tube plate comprises a corrector, which is preferably divisible.

Preferably, the tube plate has a difference in height on its edges allowing it to fit on the lifter in order to block the assembly between the tube plate and the lifter.

Advantageously, the shape of the edges of the tube plate makes it possible to affix an identifier of the barcode type thereto.

The device according to the invention is designed to process up to 96 samples simultaneously while complying with the plate format standards defined by ANSI/SLAS (American National Standards Institute—Society for Laboratory Automation and Screening) for analysis process automation.

The present invention also relates to a method for analyzing solid biological elements implementing the above device and comprising in particular the steps below:

removing the stopper from a tube of a tube plate, depositing the element to be analyzed in this tube and closing said tube with this same stopper;

introducing a lysis solution into each deep well of a deep-well plate;

inserting the tube plate into the deep-well plate, the lysis solution then penetrating into each tube of the tube plate via their perforated lower end;

incubating, with stirring, the assembly consisting of the tube plate inserted into the deep-well plate;

inserting the lifter between the tube plate and the deep-well plate while keeping them inserted so as to carry out the spinning of the element to be analyzed contained in each tube;

removing the tube plate and the lifter from the deep-well plate. The deep-well plate that contains the lysate is ready for the next step of nucleic acid purification.

Advantageously, the method comprises a step carried out following the first step, consisting in repeating sequentially, for each tube of the tube plate, the operation consisting in removing the stopper from the tube, depositing an element to be analyzed in this tube, and closing the tube using its stopper. This avoids any cross-sample contamination between the tubes.

The following description, which is in no way limiting, should be read in conjunction with the appended figures, including:

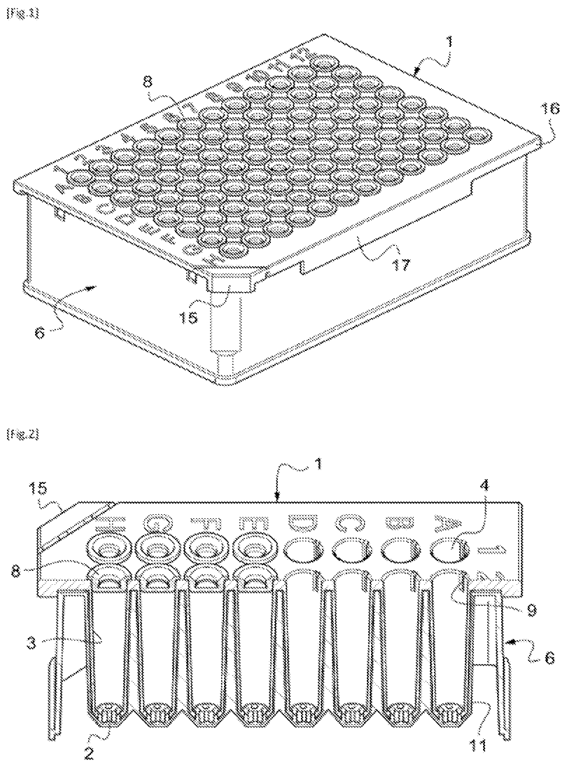

FIG. 1 is a perspective view of a device according to the present invention comprising a tube plate with stoppers inserted into a deep-well plate;

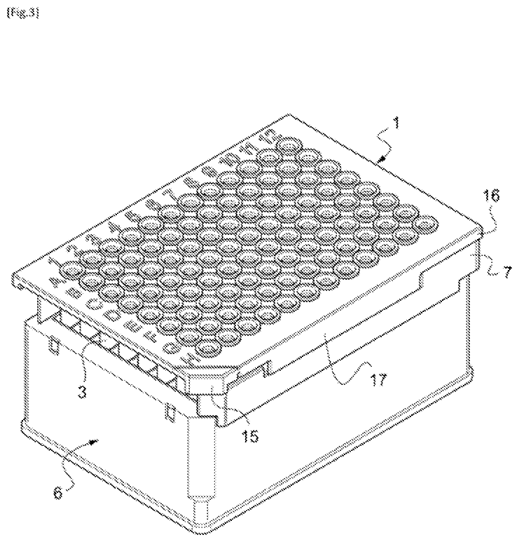

FIG. 2 is a sectional view of the device according to FIG. 1, some tubes having a stopper and others not;

FIG. 3 shows a perspective view of the device according to FIG. 1, the tube plate being raised in the deep-tube plate;

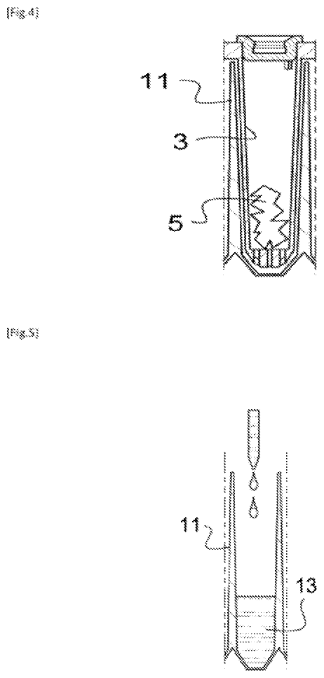

FIG. 4 schematically shows a sectional view of a tube of the tube plate, according to the present invention, stoppered after introduction of a sample;

FIG. 5 schematically shows a sectional view of a deep well of the deep-well plate into which a lysis solution is poured;

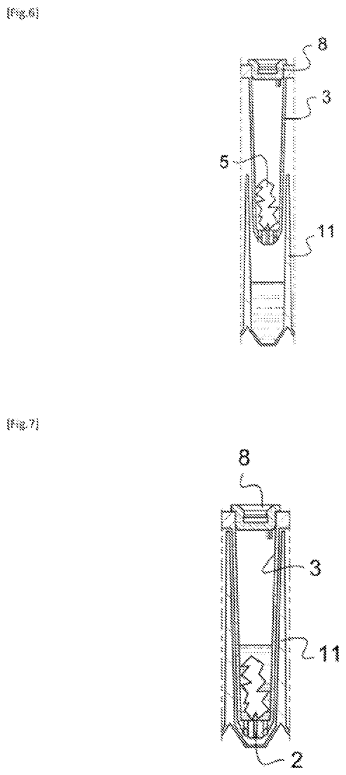

FIG. 6 schematically shows a sectional view of the insertion of a tube of the tube plate into a deep well of the deep-well plate;

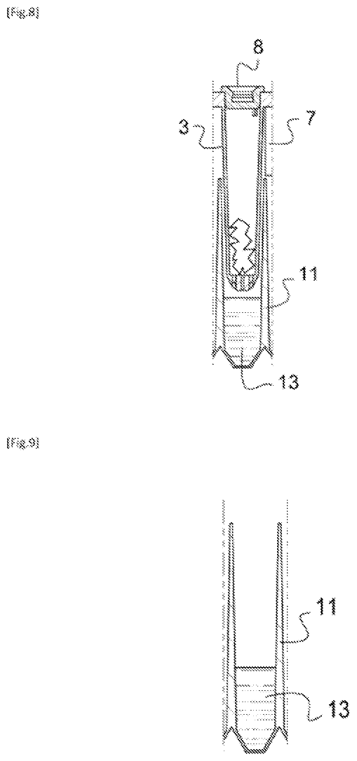

FIG. 7 schematically shows a sectional view of the tube and deep well assembly during the cell lysis phase;

FIG. 8 schematically shows a sectional view of the spinning phase, the tube plate being raised in the deep-well plate;

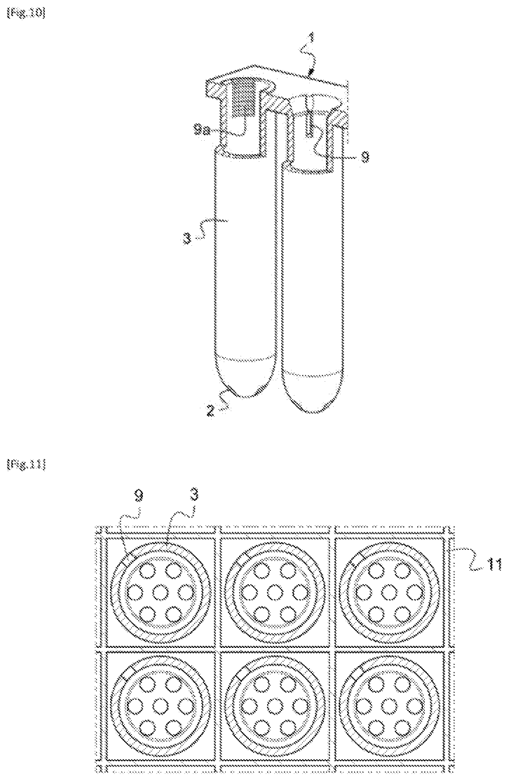

FIG. 9 schematically shows a sectional view of the deep well after removal of the tube;

FIG. 10 is a partial cutaway perspective view of tubes of a portion of the tube plate comprising at least one opening;

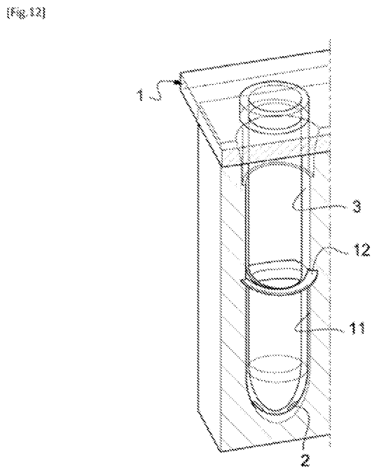

FIG. 11 is a schematic sectional view, from above, of some tubes inserted into deep wells;

FIG. 12 is a cutaway view of a tube with a non-return membrane in a deep well.

As shown in these figures, a device for analyzing solid biological elements comprises, on the one hand, a tube plate, designated as a whole by numerical reference 1: the lower end 2 of each tube 3 is perforated and the upper end 4 is open at the tube plate 1 to allow the introduction of an element to be analyzed 5 and, on the other hand, a deep-well plate, designated as a whole by numerical reference 6 into which the tube plate 1 is inserted. This device also comprises a means for separating the tube plate from the deep-well plate, such as a lifter 7. This lifter 7 is for example constituted by a U-shaped fork that is placed on the outer edges of the deep-well plate 6 and under the outer edges of the tube plate 1 in order to raise the latter with respect to the deep-well plate 6.

Each tube 3 of the tube plate 1 is closed off by a stopper 8 that makes it possible to ensure the non-contamination of the elements to be analyzed.

According to the present invention, the lower end 2 of each tube 3 has a shape that matches the shape of the bottom of the deep-well plate 6 without being in contact therewith.

According to the present invention, each tube 3 of the tube plate 1 comprises, toward its upper end 4, at least one opening 9 passing all the way through the wall of the tube 3 to allow air to pass. This opening 9 is a groove that is made in the wall of the tube 3 and that opens at the upper end 4 of the tube 3. This groove 9, which is made in the wall of the tube 3, has the function of balancing the atmospheric air pressure between the inner part and the outer part of the tube 3 when a stopper 8 is present. The length of this groove 9 begins at the upper end 4 of the tube 3 and ends, for its lower part, preferably just below the position of the stopper 8 once the latter has been inserted into the tube 3. The lower end of the groove 9 may be a few millimeters longer than the position of the stopper 8, but is not intended to come into contact with the lysis buffer. Such a groove 9 is located as high as possible on the tube 3 so as not to be in contact with the lysis solution 13 or the sample 5. This groove 9 preferably has a width of at least 0.1 mm, in particular between 0.1 mm and 5 mm, in order to create an air exchange space between the inside and the outside of the tube 3.

The positioning of the groove 9 up to the upper end 4 of the tube 3 makes it possible to make the opening visible from above the plate 1 when no stopper 8 is inserted into the tube 3. Thus, the operator can ensure that the sample 5 does not come into direct contact with the groove 9, or failing that, that no element that may separate from the sample 5 comes to obstruct this groove 9 during the insertion of the sample 5 into the tube 3.

Preferably, and as shown in FIG. 10, the groove 9 is provided with a membrane 9a that is permeable to air only. This membrane 9a positioned on or in the groove 9, preferably over the entire length of the groove 9, makes it possible to prevent volatile compounds separating from the sample 5 from escaping from the tube 3 through the groove 9 during insertion of the sample 5, thus avoiding any risk of inter-sample contamination within the tube plate 1. In the particular embodiment illustrated in FIG. 10, the membrane 9a is positioned on the groove 9 and covers the latter. As a variant, the width of the groove 9 can be equal to the width of the membrane 9a. The membrane 9a can for example be made of filter paper or plastic or any other material allowing only air to pass or can be in the form of a flexible membrane split in the middle that would open according to the change in air pressure.

According to one non-limiting embodiment, the groove 9 may comprise two parts with different dimensions and possibly forming an angle between them.

The stopper 8 closes off the upper part of the groove 9 at the upper end 4 of the tube 3, thus avoiding any contamination of the tube by exogenous elements.

The number of openings 9 is between 1 and 4. When the tube 3 has 4 openings 9, the deep wells 11 have square sections and the opening(s) 9 are arranged along the diagonal(s) of this square section.

Each tube 3 may comprise, on its outer wall, a non-return membrane 12 cooperating with the inner wall of the corresponding deep well 11. According to one embodiment, this membrane 12 is embedded in a reinforcement of the tube 3.

In a preferred version, the tube plate 3 comprises a corrector 15 located at one of its corners so as to allow only one direction of insertion of the tube plate 3 into the deep-well plate 6 and thus prevent any reversal of the device. This corrector 15 is divisible so that the tube plate 3 can be adapted to any other model of deep-well plate if necessary.

In an even more preferred version, the tube plate 3 comprises edges 16 that fit over the lifter 7 to block the assembly between the tube plate 3 and the lifter 7. These edges 16 have a higher central section 17 in order to affix a barcode-type identifier.

The present invention also relates to a method for analyzing solid biological elements implementing the device described above and comprising in particular the steps below:

removing the stopper 8, depositing the element to be analyzed 5 in a tube 3 of a tube plate 1 and closing this tube 3 with this stopper 8;

dispensing the lysis solution 13 into each deep well 11 of the deep-well plate 6;

inserting the tube plate 1 into the deep-well plate 6, the lysis solution 13 then penetrating into each tube 3 via the perforated lower end 2;

incubating, with stirring, the assembly consisting of the tube plate 1 inserted into the deep-well plate 6;

raising the tube plate 1 by means of the lifter 7 so that the lower ends 2 are no longer in contact with the lysis solution 13 to perform a dewatering phase by centrifugation;

removing the tube plate 1 from the deep-well plate 6.

Advantageously, the method also comprises a step carried out following the first step, consisting in repeating sequentially, for each tube 3 of the tube plate 1, the operation consisting in removing the stopper 8 from the tube 3, depositing an element to be analyzed 5 in this tube 3, and closing the tube 3 using its stopper 8. This avoids any cross-sample contamination between the tubes 3.

As the person skilled in the art will have noted, the lysis solution 13 is introduced directly into each deep well 11 and the tube plate 1 is then inserted into the deep-well plate 6 so that the lysis solution 13 penetrates in each tube 3 by the lower end 2 of the latter, which comprises holes, generally seven in number.

The presence of the opening 9 makes it possible to carry out an air exchange between the interior and the exterior of the tube 3 when the stopper 8 is present at the upper end 4 of the tube 3. When inserting the tube plate 1 into the deep-well plate 6, the opening 9 has the effect of promoting leveling of the lysis solution 13 liquid between the interior of the tube 3 and the interior of the deep well 11 so that the element to be analyzed 5 is completely immersed in the lysis solution 13.

In an alternative version, the tube 3 can also be provided with a flexible membrane 12 cooperating with the inner wall of the deep well 11: this flexible wall prevents the lysis solution 13 from rising too much between the tubes 3 and the deep wells 11 and thus contributes to causing the lysis solution 13 to penetrate into the tube 3 via the holes located at its lower end 2.

The holes located at the lower end 2 of the tubes 3 are exclusively oriented vertically so that no hole is in the direction of another tube 3. Only the holes located at the lower end 2 of the tube 3 make it possible to carry out a transfer of liquid between the interior and the exterior of the tubes 3.

The lower end 2 of the tube 3 can also be provided with a filter 15 arranged above the holes that it comprises. This filter has the particular function of preventing small particles from the sample present in the tube 3 from passing through the holes and thus from passing into the lysis solution 13 present in the corresponding deep well 11.

The device according to the present invention therefore ensures that each tube 3 of the tube plate 1 is free of any contamination before and during use because all the tubes 3 of the tube plate 1 are closed by a stopper 8.

For the implementation of the method described above, an automaton can be used that will remove the stopper 8 from a determined tube 3 in order to introduce an element to be analyzed into this tube 3 without risk of contamination of the adjacent tubes 3, which are still stoppered. The automaton will only raise one stopper 8 at a time and put it back in place once the element to be analyzed has been introduced into the tube 3. In addition, the automaton can be equipped with an optical system to take an image of each element to be analyzed in order to ensure traceability of operations.

According to the present invention, the stopper 8 of a tube 3 is manipulated only once in order to insert an element to be analyzed into the tube 3. This ensures that no cross-contamination can occur during processing.

Moreover, as already mentioned, this device can be easily automated and can be coupled with traceability software in order to control the opening and closing of each tube 3 and thus guarantee the correct positioning of each sample.

Thus, the device for analyzing solid biological elements according to the present invention makes it possible, in particular in the medical field or the forensic science field, to meet the requirements of the international standard ISO/IEC 17025 relating to analysis and test laboratories. The requirements of the standard focus in particular on the fight against contamination and the traceability of samples from receipt of the sample in the laboratory to the reporting of the results. The preliminary step, called sampling, which consists in positioning a given sample (or a fraction of a sample) in its location for analysis, as well as the cell lysis step, are the two steps of the method of the present invention, and present all the necessary guarantees to avoid any risk of sample inversion or contamination.

1. Device for analyzing solid biological elements comprising a plate of tubes, the lower ends of which are perforated and the upper ends of which are open at the tube plate to allow the introduction of an element to be analyzed, and a deep-well plate into which the tube plate is inserted, the deep-well plate comprising several deep wells, the device further comprising a lifter for raising the tube plate from the deep-well plate, each tube of the tube plate comprising, toward its upper end, at least one opening passing all the way through the wall of the tube to allow air to pass through, the device further comprising, for each tube of the tube plate, a stopper closing the upper end of the tube;
characterized in that the opening is a groove made in the wall of the tube, and opening up to the upper end of the tube.

2. Device according to claim 1, characterized in that the groove has a width in the range of 0.1 mm to 5 mm.

3. Device according to claim 1, characterized in that each tube comprises a membrane positioned on or within the groove, preferably over the entire length of the groove, such a membrane being configured to allow only air to pass.

4. Device according to claim 1, characterized in that the upper part of the groove at the upper end of the tube is closed by the stopper.

5. Device according to claim 1, characterized in that the deep wells have square sections and in that the opening(s) are arranged along the diagonal(s) of this square section.

6. Device according to claim 1, characterized in that each tube comprises, on its outer wall, a non-return membrane cooperating with the inner wall of the corresponding deep well.

7. Device according to claim 6, characterized in that this membrane is embedded in a reinforcement of the tube.

8. Device according to claim 1, characterized in that at one of its corners, the tube plate comprises a corrector.

9. Device according to claim 8, characterized in that the corrector is divisible.

10. Device according to claim 1, characterized in that the tube plate comprises edges inserted onto the lifter in order to block the assembly between the tube plate and the lifter.

11. Device according to claim 10, characterized in that the edges of the tube plate have a higher central section in order to affix an identifier of the barcode type thereto.

12. Method for analyzing biological samples implementing the device according to claim 1 and comprising in particular the steps below:
removing the stopper from a tube of a tube plate, depositing the element to be analyzed in this tube and closing said tube with this same stopper;
introducing a lysis solution into each deep well of a deep-well plate;
inserting the tube plate into the deep-well plate, the lysis solution then penetrating into each tube of the tube plate via their perforated lower end;
incubating, with stirring, the assembly consisting of the tube plate inserted into the deep-well plate;
inserting the lifter between the tube plate and the deep-well plate while keeping them inserted to spin the element to be analyzed contained in each tube;
removing the tube plate from the deep-well plate.
